(19) United States
(12) Patent Application Publication
(10) Pub. No.: US 2017/0027224 A1
(43) Pub. Date: Feb. 2, 2017

(54) PORTABLE VAPORIZER

(71) Applicant: Puff Corp., Old Bridge, NJ (US)

(72) Inventor: Roger Volodarsky, Old Bridge, NJ (US)

(73) Assignee: PUFF CORP., Old Bridge, NJ (US)

(21) Appl. No.: 14/815,765

(22) Filed: Jul. 31, 2015

(51) Int. Cl. A24F 47/00; H05B 3/02

(52) U.S. Cl. CPC A24F 47/008; H05B 3/026

(57) ABSTRACT

A portable vaporizer for vaporizing product to be inhaled by a user of the vaporizer. Vapors are generated by heating product in a product chamber with a heating element. The portable vaporizer eliminates the risk of vaporized glues or adhesives by securing the product chamber with a retaining element.

### FIELD OF THE INVENTION

The present invention generally relates to portable vapor delivery systems. More specifically, the present invention relates to portable vaporizers for delivery of inhalable substances.

### BACKGROUND OF THE INVENTION

Portable vaporizers such as electronic cigarettes are known in the art for vaporizing tobacco and other products to generate an inhalant that may be inhaled by a user of an electronic cigarette. See, e.g., U.S. Pat. No. 9,038,642. Portable vaporizers typically include a power source such as a rechargeable battery, a heating element to heat the product, a product chamber to hold the product to be heated, and a mouthpiece through which vapors emitted from the product may be inhaled by the user. A user may inhale the vapors by drawing on the mouthpiece, causing air to be pulled from the surrounding environment through the product chamber, and through the mouthpiece to the user's mouth.

The product chamber is typically a separate component from the outer housing of the vaporizer. Manufacturers have used glue or other adhesives to hold the product chamber within the housing. During use of the vaporizer, the heating element and the product chamber may rise to a high temperature. The excessive heat may cause the glue or other adhesive to vaporize, resulting in inhalation of fumes from the glue or adhesive. Inhalation of vaporized fumes from the glue or other adhesives may affect the taste of the vapors from the heated product, and may have an adverse effect on the health of the user.

### SUMMARY OF THE INVENTION

Presented herein is a portable vaporizer including a housing, a heating element and a product chamber. The product chamber is held in the housing of the vaporizer by a retaining element without the use of glue or adhesives. The retaining element may be held in position by, for example, a friction fit between the outer surface of the retaining element and the inner wall of the housing, or by mating screw threads on the surface of the retaining element with screw threads on the housing. By using the retaining element to retain the product chamber in the housing without the use of glue or other adhesives, the invention eliminates the risk of fumes from glues or adhesives being inhaled by a user of the portable vaporizer.

The portable vaporizer may also limit the amount of time that the heating element may be continuously activated to prevent overheating or accidental fires.

The portable vaporizer may also allow a user to select one of multiple preset heating levels for the heating element.

### BRIEF DESCRIPTION OF THE DRAWINGS

A further understanding of the present principles can be determined by reference to embodiments set forth in the accompanying drawings, where like reference numbers indicate like elements throughout the drawings. The illustrated embodiments are merely exemplary products for carrying out the present principles. The drawings are not intended to limit the scope of the principles, which is set forth with particularity in the claims as appended or as subsequently amended, but merely to clarify and exemplify the principles. For a more complete understanding of the present principles, reference is now made to the following figures:

FIG. 1 is a perspective view of a portable vaporizer according to an embodiment of the present principles.

FIG. 2 is an exploded view of the portable vaporizer depicted in FIG. 1.

FIG. 3 is a perspective view of the atomizer component of the portable vaporizer depicted in FIG. 2.

FIG. 4 is a partially exploded view of the atomizer component depicted in FIG. 3.

FIG. 5 is a partially exploded view of the atomizer component depicted in FIG. 3.

FIG. 6 is a partially exploded view of the atomizer component depicted in FIG. 3.

### DETAILED DESCRIPTION OF THE INVENTION

Illustrative embodiments of the present principles are disclosed herein. However, products and methods in accordance with the present principles may be embodied in a wide variety of forms and modes, some of which may be different from those in the disclosed embodiment. Consequently, the specific structural and functional details disclosed herein are merely representative, but they are deemed to afford the best embodiment for purposes of disclosure and to provide a basis for the claims herein which define the scope of the present principles.

Well known structures, components and methods for carrying out the objectives of the present principles and illustrating the preferred embodiment are incorporated herein but have not been described in detail as not to unnecessarily obscure novel aspects of the present principles.

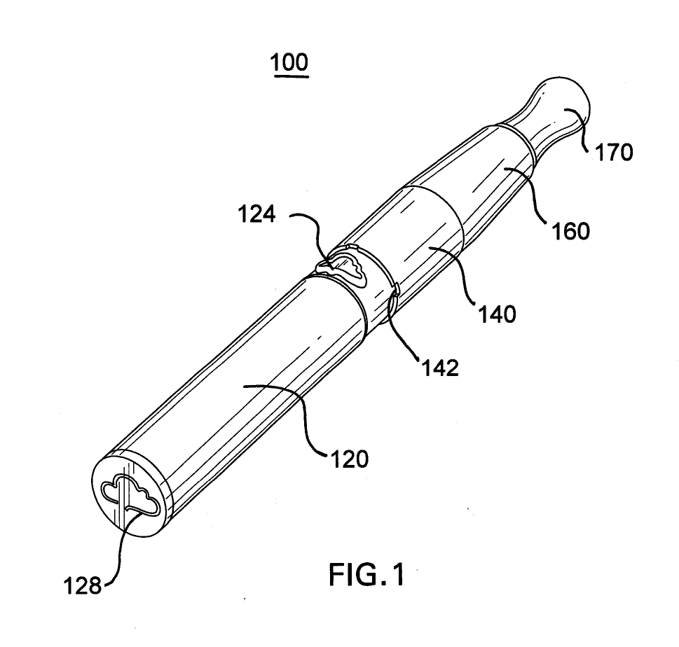

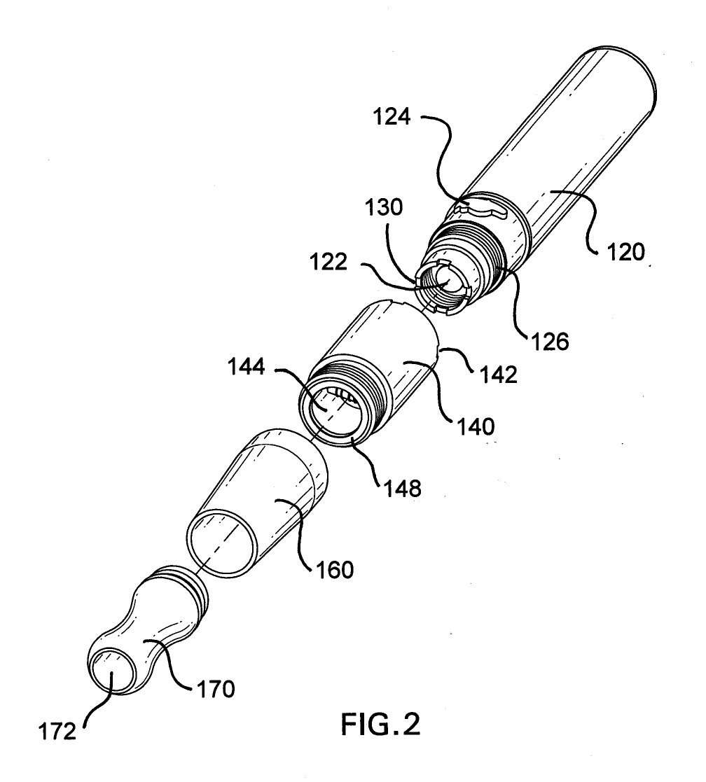

Referring to FIG. 1, a diagram illustrating an exemplary portable vaporizer (100) is shown. The vaporizer as shown comprises four main components: a battery component (120), an atomizer component (140), a first mouthpiece component (160), and a second mouthpiece component (170). FIG. 2 depicts an exploded view of the portable vaporizer (100) depicted in FIG. 1, but from the opposite perspective along the main longitudinal axis of the portable vaporizer (100).

In a preferred embodiment, the battery component (120) is comprised of a housing that has a hollow portion adapted to hold a battery (not shown). The battery component (120) may be adapted to accept one or more batteries. Also, the battery component (120) may be adapted to accept a non-rechargeable battery or a rechargeable battery. The battery component (120) may have a door (not shown) or other means to allow a battery to be inserted into and removed from the battery component (120).

If the battery component (120) is designed to accept a rechargeable battery, the battery component may have a charging port connectable to a battery charger. As shown in FIG. 2, a charging port (122) may be included at one end of the battery component (120). The charging port (122) would be in electric communication with a battery in the battery component (120). A battery charger (not shown) may be connectable to a source of electricity (e.g., a wall outlet or a computer) and connectable to the charging port (122) to charge the rechargeable battery. Rechargeable batteries and means for charging them are well known in the prior art.

The other end of the battery component (120) may include a light (128) that is activated when the portable vaporizer is used as described below. As described below, the light (128) may signal, for example, when the portable vaporizer (100) is locked or unlocked. The light (128) may also indicate one of multiple heating levels that may be selected by the user.

In a preferred embodiment, the atomizer component (140) comprises a housing with circumferential walls. As shown in FIG. 2, one end of the atomizer component (140) may be mechanically attachable to one end of the battery component (120). The atomizer component (140) may be attached to the battery component (120) by screw threads on the battery component (126) which may be mated to screw threads (not shown) on the atomizer component. The battery component (120) and the atomizer component (140) may also be attached by other means known in the art for attaching two product parts, including snapping the parts together. In an alternative embodiment, the battery component (120) and atomizer component (140) may be formed as one component from a single housing.

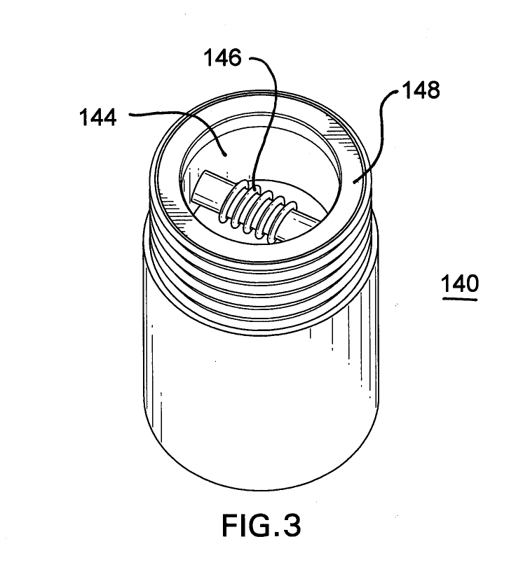

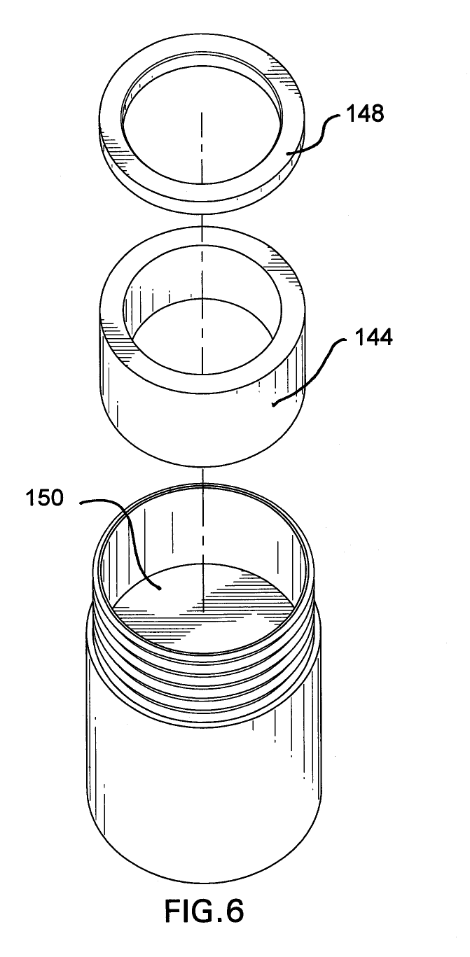

FIGS. 3-6 depicts an atomizer component (140). As shown in FIG. 6, the atomizer component (140) may have a cavity (150). The cavity (150) may have a base and circumferential walls. As showed in FIGS. 2-5, the cavity may have a product chamber (144) disposed therein. As shown in FIG. 6, in a preferred embodiment, the product chamber (144) is shaped as a cup with a base and circumferential walls having a cylindrical cross-section. The exterior of the product chamber (144) may be of the same shape and slightly smaller dimensions than the interior walls of the cavity (150). In addition, the height of the walls of the product chamber (144) may be lower than the height of the walls of the cavity (150). The internal volume of the product chamber (144) may be, for example, 2.1 cubic centimeters. Also, in a preferred embodiment, the product chamber (144) is made from a ceramic material.

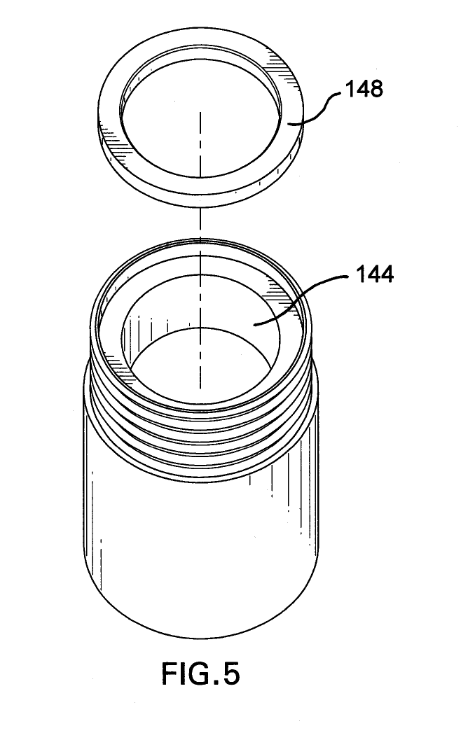

To secure the product chamber (144) in the housing of the atomizer component (140), a retaining element (148) may be fitted at the open end of the cavity (150). The retaining element (148) may have at least one opening through which the product to be vaporized can be inserted into the product chamber (144). In a preferred embodiment, the retaining element (148) is shaped as a ring (as shown in FIG. 5) and is made from a metal such as stainless steel. The height of the retaining element (148) may be approximately equal to the difference between the exterior height of the walls of the product chamber (144) and the interior height of the walls of the cavity (150) in the atomizer component (140). The retaining element (148) may have a size and shape required to friction fit the retaining element (148) at the opening of the cavity (150) by mechanically engaging the outer surface of the retaining element (148) with the inner surface of the walls of the cavity (150). Pressing the retaining element (148) into the open end of the cavity (150) may cause the open end of the cavity (150) to expand slightly to accept the retaining element (148). The retaining element (148) may also be fitted at the open end of the cavity (150) by engaging screw threads on the retaining element (148) with screw threads on the housing of the atomizer component (140).

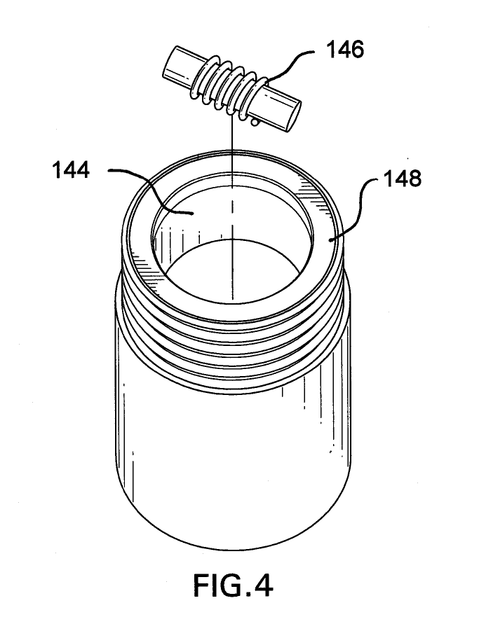

As shown in FIG. 3, a heating element (146) may be disposed within the product chamber (144) for heating product placed within the product chamber (144). The heating element (146) is preferably located at or near the bottom of the product chamber (144). The heating element (146) may comprise a metal wire. As indicated in FIGS. 3 and 4, the wire may be wrapped one or more times around a heat sink such as a ceramic post. The heating element (146) is also electrically connected to a battery in the battery component (120). For example, the heating element may be electrically connected to the battery by a wire that passes through an opening in the bottom of the product chamber (144) and through an opening in the base of the cavity (150).

The portable vaporizer (100) may have a first mouthpiece component (160) and a second mouthpiece component (170). Both the first mouthpiece component (160) and the second mouthpiece component (170) are formed from hollow housings, and each has a first opening and a second opening. The first mouthpiece component (160) may be mechanically attached to the atomizer component (140), and the second mouthpiece component (170) may be mechanically attached to the first mouthpiece component (160). A mouthpiece may also be formed as one component from a single housing.

An ultraviolet (UV) protective coating may be applied to the components of the portable vaporizer (100). For example a UV coating may be applied to the housing of a battery component (120), the housing of an atomizer component (140), the housing of a first mouthpiece component (160), and the housing of a second mouthpiece component (170). The UV coating may protect the portable vaporizer (100) from scratches, may preserve the color of the portable vaporizer (100), and if the housings are made from metal, may prevent patina from forming on the housings.

The portable vaporizer (100) may have a button (124) or other means of operating the portable vaporizer. The button (124) may be used to activate the heating element (146). For example, when the button is depressed, an internal circuit connecting the battery and the heating element (146) may be completed, allowing electricity to pass through the heating element (146). The resistance of the heating element (146) causes the heating element (146) to radiate heat into the product chamber (144). Product placed in the product chamber may be vaporized by the heat emanating from the heating element (146).

The button (124) may be formed from a translucent material, such as a clear plastic, that allows one or more lights (not shown) within the button (124) or otherwise within the portable vaporizer (100) to illuminate the button (124). The button (124) may be illuminated by a light within the portable vaporizer (100) when the heating element (146) is activated.

The button (124) may also allow a user to select from different levels of available current to pass through the heating element (146). By adjusting the current passing through the heating element, the user may select from multiple levels of heat generation from the heating element (146). For example, a user may select from a preset number of heating levels by rapidly pressing the button (124) four times to advance to each successive heating level. The button (124) may illuminate with a different color for each heating level. For example, the button (124) might shine blue for the lowest heating level, green for an intermediary heating level, and red for the highest heating level. The light (128) on the battery component (120) may also illuminate with different colors to indicate the heating level. In the alternative, a sound generator within the portable vaporizer (100) may indicate the heating level. For example, if three heating levels may be selected by the user, the portable vaporizer (100) may signal each successive heating level with one, two, and three “beeps,” respectively.

The button (124) may also be used to lock and unlock the portable vaporizer (100). In a locked state, depressing the button (124) would not activate the heating element. In an unlocked state, depressing the button (124) would activate the heating element. In one embodiment, rapidly depressing the button (124) five times may switch the portable vaporizer (100) from an unlocked state to a locked state. A user may be required to depress the button (124) fives times within a predetermined period of time to lock the portable vaporizer (100). Similarly, to switch the portable vaporizer (100) from a locked state to an unlocked state whereby the heating element may be activated, the user may be required to rapidly depress the button (124) five times. The user may be required to depress the button (124) five times within a predetermined period of time to unlock the portable vaporizer (100). The portable vaporizer (100) may illuminate the button (124) to indicate that the portable vaporizer (100) has entered a locked state or an unlocked state. For example, the button (124) may illuminate five times to indicate that the portable vaporizer (100) has entered a locked state. The button may also illuminate five times to indicate that the portable vaporizer (100) has entered an unlocked state. The light (128) on the battery component (120) may also illuminate in a similar manner to indicate whether the portable vaporizer (100) has entered a locked state or an unlocked state. In the alternative, a sound generator within the portable vaporizer (100) may indicate when the portable vaporizer (100) has entered a locked state or an unlocked states by emitting a sound such as a series of “beeps.”

FIG. 1 shows an exemplary portable vaporizer (100) with the battery component (120), an atomizer component (140), a first mouthpiece component (160) and a second mouthpiece component (170). The battery component (120) is mechanically connectable to the atomizer component (140, the atomizer component (140) is mechanically connectable to the first mouthpiece component (160), and the first mouthpiece component is mechanically connectable to the second mouthpiece component (170).

To use the portable vaporizer (100), a user would detach the first mouthpiece component (160) from the atomizer component (140) and place a vaporizable product into the product chamber (144). The user would then re-attach the first mouthpiece component (160) to the atomizer component (140), and attach the second mouthpiece component (170) to the first mouthpiece component (160) if it is not already so attached. The user may then depress the button (124) to activate the heating element (146) in the product chamber (144). When the product has been heated and vaporized for the desired time, the user may inhale the vaporized fumes by drawing the fumes through opening (172) of the second mouthpiece component (170).

To prevent overheating, the portable vaporizer (100) may include electric circuitry that only permits current to pass to the heating element (146) for a pre-determined period of time regardless of the amount of time the button (124) is continuously depressed. For example, the portable vaporizer may only allow current to pass to the heating element for eight seconds, regardless of whether the button (124) is depressed for more than eight seconds.

To facilitate air flow through the portable vaporizer (100), the atomizer component (140) may have notches (142) at the base of the housing that allows air from the surrounding environment to enter the housing of the atomizer component (140). The base of the product chamber (144) and the base of the cavity (150) in the atomizer component (140) may also have openings that allow air that enters the atomizer component (140) through the notches (142) to enter the product chamber (144). The battery component (120) may also have notches (130) to facilitate the flow of air from the notches (142) in the atomizer component (140) to the openings in the base of the cavity (150) in the atomizer component (140) and the base of the product chamber (144).

As noted above, the product chamber (144) is preferably secured in the cavity (150) of the atomizer component (140) using a retaining element (148) instead of glue or other adhesives. By avoiding the use of glue or other adhesives to secure the product chamber, the present invention eliminates the risk that glue or other adhesives may be vaporized from the heat emanating from the heating element (146), and eliminates the risk of fumes from glue or adhesives being inhaled with the product vapors when the user inhales the product vapors.

While the foregoing embodiments of the principles have been set forth in considerable detail for purposes of making a complete disclosure of the principles, it will be apparent to those of skill in the art that numerous changes may be made to such features without departing from the spirit and scope of the present principles.

1. A portable vaporizer comprising:
a first housing extending along a longitudinal axis, having a first end and a second end, and being at least partially hollow so as to define a first cavity between the first end and the second end, wherein the first end has a first opening with an interior edge in fluid communication with the cavity;
a product chamber disposed in the cavity of the first housing along the longitudinal axis of the first housing and comprising a base and one or more circumferential walls;
a heating element disposed in the product chamber;
a retaining element disposed in the first opening of the first end of the first housing and held in position by friction between the retaining element and the interior edge of the first opening; and
a mouthpiece formed from a second housing extending along the longitudinal axis having a first end and a second end wherein the first end is detachably connected to the first end of the first housing.

2. The portable vaporizer according to claim 1, further comprising a third housing extending along the longitudinal axis and having a cavity adapted to receive a battery, and wherein the third housing electrically connectable to the first housing.

3. The portable vaporizer according to claim 2, further comprising a button adapted to allow a user to activate the heating element.

4. The portable vaporizer according to claim 3, wherein the button is further adapted to allow a user to select the level of current delivered to the heating element from among one or more preset current levels.

5. The portable vaporizer according to claim 4, further comprising a light that illuminates the button when the button is depressed.

6. The portable vaporizer according to claim 5, wherein the light emits a different color hue for each preset current level.

7. The portable vaporizer according to claim 6, wherein the duration of time that the heating element may be continuously activated is limited to a predetermined length of time.

8. The portable vaporizer according to claim 1, wherein the product chamber has an internal volume of 2.1 cubic centimeters.

9. The portable vaporizer according to claim 1, wherein the product chamber has an internal volume greater than 2.1 cubic centimeters.

10. A portable vaporizer comprising:
a first housing extending along a longitudinal axis, having a first end and a second end, and being at least partially hollow so as to define a first cavity between the first end and the second end, wherein the first end has a first opening with an interior edge in fluid communication with the cavity;
a product chamber disposed in the cavity of the first housing along the longitudinal axis of the first housing and comprising a base and one or more circumferential walls;
a heating element disposed in the product chamber;
a retaining element disposed in the first opening of the first end of the first housing and held in position by friction between the retaining element and the interior edge of the first opening, wherein the retaining element is ring-shaped; and
a mouthpiece formed from a second housing extending along the longitudinal axis having a first end and a second end wherein the first end is detachably connected to the first end of the first housing.

11. The portable vaporizer according to claim 10, wherein the portable vaporizer limits the duration of time that the heating element may be continuously activated to a predetermined length of time.

12. The portable vaporizer according to claim 11, wherein the product chamber has an internal volume of 2.1 cubic centimeters.

13. The portable vaporizer according to claim 12, further comprising a button adapted to allow a user to activate the heating element.

14. The portable vaporizer according to claim 13, wherein the button is adapted to allow a user to lock the portable vaporizer by depressing the button a predetermined number of times.

15. The portable vaporizer according to claim 14, wherein the button is adapted to allow a user to lock the portable vaporizer by depressing the button a predetermined number of times within a preset period of time.

16. A portable vaporizer comprising:
a first housing extending along a longitudinal axis, having a first end and a second end, and being at least partially hollow so as to define a first cavity between the first end and the second end, wherein the first end has a first opening with an interior edge in fluid communication with the cavity;
a product chamber disposed in the cavity of the first housing along the longitudinal axis of the first housing and comprising a base and one or more circumferential walls;
a heating element disposed in the product chamber;
a retaining element attached to the first end of the first housing by mating screw threads on the retaining element with screw threads on the first housing; and
a mouthpiece formed from a second housing extending along the longitudinal axis having a first end and a second end wherein the first end is detachably connected to the first end of the first housing.

17. The portable vaporizer according to claim 16, wherein the retaining element is ring-shaped.
